(19) United States
(12) Patent Application Publication
(10) Pub. No.: US 2017/0269823 A1
(43) Pub. Date: Sep. 21, 2017

(54) Control Display Method and Device, and Terminal

(71) Applicant: ZTE Corporation, Shenzhen (CN)

(72) Inventor: Zhanfeng WANG, Shenzhen (CN)

(21) Appl. No.: 15/509,678

(22) PCT Filed: Nov. 7, 2014
(86) PCT No.: PCT/CN2014/090638

§ 371 Date: Mar. 8, 2017

(30) Foreign Application Priority Data
Aug. 14, 2014 (CN) 201410399472.9
Sep. 17, 2014 (CN) 201410475268.0

(51) Int. Cl. G06F 3/0484; H04M 1/725

(52) U.S. Cl. CPC G06F 3/04845; H04M 1/72583

(57) ABSTRACT

A control display method and device (62), and a terminal (60) are provided. In the method, it is detected that a position of a control, for being displayed, on an interface of a mobile terminal is changed (S102); whether a termination position after changing is located in a preset interface layout in the mobile terminal or not is judged (S104); under a condition that a judgment result is that the termination position after changing is not located in the preset interface layout, the preset interface layout is changed into an interface layout adapted to the termination position of the control (S106); and the control is displayed at the termination position of the changed interface layout (S108).

### TECHNICAL FIELD

The present disclosure relates to the field of communications, and more particularly to a control display method and device, and a terminal.

### BACKGROUND

In a terminal product made according to a related technology, a user can move, in a fixed mode, using positions of a control for part of applications or a sub-function entry point, such as a picture button. In the stage of product design and after the product is launched, movement of the position of the control which can be operated by the user is fixed, that is, the control can be move only by a fixed distance or an integral multiple of the fixed length. The control cannot be freely moved by a distance smaller than the fixed length, or a distance which is not an integral multiple of the fixed length. The user is not allowed to freely modify the position of this type of control which can be operated by the user. Such a software designing situation and product implementation situation that positions of controls in applications are fixed may disable users to freely perform position movement on the positions of the controls according to personal preferences and using habits, thereby causing influence on using experiences of the users. Facing different preferences and habits of different users while using the same application, application software of products of terminal manufacturers cannot meet preferences and habits of all users because it is difficult to cater for all tastes.

Moreover, in all related technologies, a manner of collecting statistics on using frequencies of a user is adopted to regulate a sequence of menu items in a menu of an application of a mobile terminal. For example, in a patent application with an application No. 200510131971.0, a sequence of menu items is dynamically regulated according to the statistics on menu item using frequencies of a user. For another example, in a patent application with an application No. 200910051359.0, the same manner is adopted. For another example, in a patent application with an application No. 201210152546.X, a menu and a sequence of menu items are also regulated according to statistics on using frequencies of a user.

These related technologies have at least three obvious defects. A first defect is that in the related technologies, a control such as a picture button cannot be placed at a position which is not an integral multiple of a set interval. A second defect is that in the related technologies, a sequence of menu items of menu controls is regulated, but for positions of controls such as a text button, an icon button, a list item, a textbox and an editable textbox, a user cannot modify and regulate a position of each control in an application or a position outside the application by a user operation. A third defect is that in the related technologies, after a mobile terminal product leaves factory and is then launched, the mobile terminal collects statistics on using frequencies of a user, and then a sequence of menu items may be regulated according to the frequencies or other rules. In other words, in solutions of the related technologies, the user can regulate the sequence of the menu items only after using the mobile terminal for a period of time, that is, the mobile terminal can gradually regulate the sequence of the menu items according to the using frequencies of the user only after experiencing a using process of the user. It can be concluded that in the related technologies, the user cannot freely regulate positions of controls directly according to his/her own using habits and preferences after immediately getting the mobile terminal.

For the problem that a user cannot freely regulate a position of a control on a terminal immediately after getting the terminal in the related technology, there is yet no effective solution.

### SUMMARY

Embodiments of the present disclosure provide a control display method and device, and a terminal, so as to at least solve the problem that a user cannot freely regulate a position of a control on the terminal immediately after getting the terminal in the related technology.

According to an aspect of the embodiments of the present disclosure, a control display method is provided, which may include that: it is detected that a position of a control, for being displayed, on an interface of a mobile terminal is changed; whether a termination position after changing is located in a preset interface layout in the mobile terminal or not is judged; under a condition that a judgment result is that the termination position after changing is not located in the preset interface layout, the preset interface layout is changed into an interface layout adapted to the termination position of the control; and the control is displayed at the termination position of the changed interface layout.

Optionally, after the step that the control is displayed at the termination position of the changed interface layout, the method may further include that: termination attribute information used for recording to display the control at the termination position of the changed interface layout is stored.

Optionally, after the step that the termination attribute information used for recording to display the control at the termination position of the changed interface layout is stored, the method may further include that: under a condition of detecting that the position of the control, for being displayed, is changed for multiple times, multiple pieces of termination attribute information corresponding to the control of which the position is detected to be changed for multiple times are updated and stored.

Optionally, the termination attribute information of the control may include at least one of: a name of an application to which the control belongs, a name of the interface in which the control is positioned, a control name or control Identity (ID) of the control, a category of the control, the changed interface layout, and termination position information after the position of the control is changed for one or multiple times.

Optionally, after the step that the control is displayed at the termination position of the changed interface layout, the method may further include that: when the control is displayed again after the interface is quitted, the control is displayed at the termination position of the changed interface layout.

According to another aspect of the embodiments of the present disclosure, a control display device is provided, which may include: a detection module, arranged to detect that a position of a control, for being displayed, on an interface of a mobile terminal is changed; a judgment module, arranged to judge whether a termination position after changing is located in a preset interface layout in the mobile terminal or not; a changing module, arranged to, under a condition that a judgment result of the judgment module is that the termination position after changing is not located in the preset interface layout, change the preset interface layout into an interface layout adapted to the termination position of the control; and a first displaying module, arranged to display the control at the termination position of the changed interface layout.

Optionally, the control display device may further include: a storage module, arranged to store termination attribute information used for recording to display the control at the termination position of the changed interface layout.

Optionally, the control display device may further include: an updating and storage module, arranged to, under a condition of detecting that the position of the control, for being displayed, is changed for multiple times, update and store multiple pieces of termination attribute information corresponding to the control of which the position is detected to be changed for multiple times.

Optionally, the control display device may further include: a second displaying module, arranged to, when the control is displayed again after the interface is quitted, display the control at the termination position of the changed interface layout.

According to another aspect of the embodiments of the present disclosure, a terminal is provided, which may include any abovementioned control display device.

According to the embodiments of the present disclosure, a method of detecting that a position of a control, for being displayed, on an interface of a mobile terminal is changed, judging whether a termination position after changing is located in a preset interface layout in the mobile terminal or not, changing the preset interface layout into an interface layout adapted to the termination position of the control under a condition that the judgment result is negative and displaying the control at the termination position of the changed interface layout is adopted. The problem that a user cannot freely regulate the position of the control on the terminal immediately after getting the terminal in the related technology is solved. An effect that the user can freely regulate the position of the control according to his/her own preference is further achieved.

### BRIEF DESCRIPTION OF THE DRAWINGS

The drawings described here are adopted to provide a further understanding to the present disclosure, and form a part of the present disclosure. Schematic embodiments of the present disclosure and descriptions thereof are adopted to explain the present disclosure and not intended to form improper limits to the present disclosure. In the drawings:

FIG. 1 is a flowchart of a control display method according to an embodiment of the present disclosure;

FIG. 2 is a structure block diagram of a control display device according to an embodiment of the present disclosure;

FIG. 3 is a first exemplary structure block diagram of a control display device according to an embodiment of the present disclosure;

FIG. 4 is a second exemplary structure block diagram of a control display device according to an embodiment of the present disclosure;

FIG. 5 is a third exemplary structure block diagram of a control display device according to an embodiment of the present disclosure;

FIG. 6 is a structure block diagram of a terminal according to an embodiment of the present disclosure;

FIG. 7 is a schematic diagram of modifying a control of an application interface by a user according to an embodiment of the present disclosure;

FIG. 8 is a drawing diagram of positions of controls according to an embodiment of the present disclosure;

FIG. 9 is an original layout of an interface of a mobile phone according to an embodiment of the present disclosure; and

FIG. 10 is a layout of an interface of a mobile phone after control movement according to an embodiment of the present disclosure.

### DETAILED DESCRIPTION OF THE EMBODIMENTS

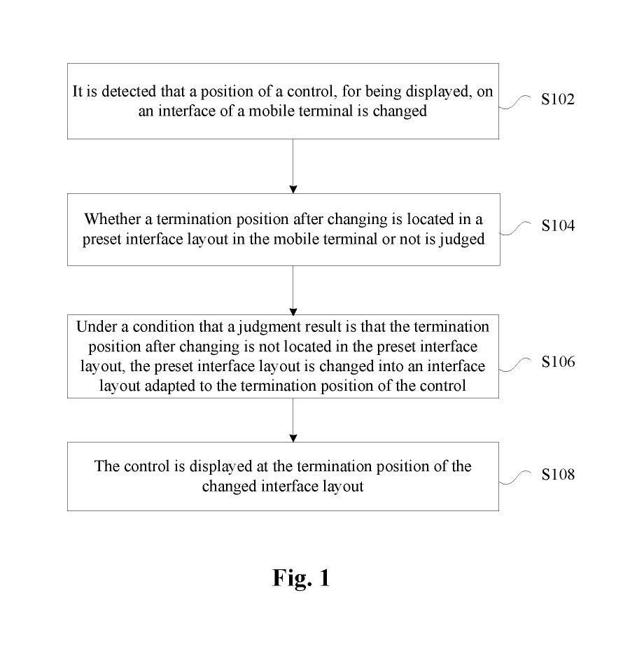

The present disclosure will be described below with reference to the drawings and the embodiments in detail. It is important to note that the embodiments in the present disclosure and characteristics in the embodiments may be combined under a condition of no conflicts. The embodiment provides a control display method. FIG. 1 is a flowchart of a control display method according to an embodiment of the present disclosure. As shown in FIG. 1, the flow includes the following steps.

Step S102: it is detected that a position of a control, for being displayed, on an interface of a mobile terminal is changed.

Step S104: whether a termination position after changing is located in a preset interface layout in the mobile terminal or not is judged.

Step S106: under a condition that a judgment result is that the termination position after changing is not located in the preset interface layout, the preset interface layout is changed into an interface layout adapted to the termination position of the control.

Step S108: the control is displayed at the termination position of the changed interface layout.

By the steps, it is detected that the position of the control, for being displayed, on the interface of the mobile terminal is changed; whether the termination position after changing is located in the preset interface layout in the mobile terminal or not is judged; under a condition that the judgment result is negative, the preset interface layout is changed into the interface layout adapted to the termination position of the control; and the control is displayed at the termination position of the changed interface layout. By virtue of the technical scheme, the interface layout can be formed according to the changed position of the control to break up a conventional fixed form for displaying an interface layout, so that the control can be moved to any position. The problem that a user cannot freely regulate the position of the control on the terminal immediately after getting the terminal in the related technology is solved. An effect that the user can freely regulate the position of the control according to his/her own preference is further achieved, and user experiences are improved. The position of the control may be moved in a dragging manner, that is, the user can select the control of which the position is required to be modified by long pressing and place the control at a new position in a manner of dragging the control in an application interface of the mobile terminal. If the position of the control has never been changed, the preset interface layout refers to an interface layout when the terminal initially leaves factory. If the position of the control has ever been changed, the preset interface layout refers to an interface layout stored when an interface where the control is positioned is quitted last time. Moreover, positions of a control correspond to interface layouts one to one, that is, different positions of the control may correspond to different interface layouts, and the two are in an adapted relationship. After the termination position of the control is changed, the preset interface layout can automatically be changed into the interface layout adapted to the termination position of the control in the terminal.

In an exemplary embodiment, after the step that the control is displayed at the termination position of the changed interface layout, the method may further include that: termination attribute information used for recording to display the control at the termination position of the changed interface layout is stored. In such a manner, when the control is displayed again, the user is able to select to display the control according to the original interface layout, or to display the control according to the changed interface layout, so that selectivity for control display can be improved.

Moreover, after the step that the termination attribute information used for recording to display the control at the termination position of the changed interface layout is stored, multiple pieces of termination attribute information corresponding to the control of which the position is detected to be changed for multiple times may also be updated and stored under a condition of detecting that the position of the control configured for displaying is changed for multiple times. As an exemplary implementation, the termination attribute information of the control after the position of the control is changed may be stored in the mobile terminal by virtue of a configuration file, or a database or another storage module. Updating and storage mentioned here may include two storage manners. In one manner, multiple pieces of termination attribute information corresponding to the control of which the position is changed are simultaneously stored, and then a system may prompt the user for control position selection when the control is displayed again, so that the same terminal may be enabled to meet preferences and habits of different users. In the other manner, only latest termination attribute information corresponding to the control of which the position is changed is stored, that is, original termination attribute information corresponding to the same control of which the position is changed is replaced with the latest termination attribute information corresponding to the control of which the position is changed, so that it can be ensured that the control of the mobile terminal can appear at the position after changing on the interface every time. In this way, the user is not required to set the position of the control every time, and convenience and simplicity for operation are ensured.

The termination attribute information of the control may include at least one of the following information: a name of an application to which the control belongs, a name of an interface where the control is positioned, a control name or control ID of the control, a category of the control, the changed interface layout, and termination position information after the position of the control is changed for one or multiple times. The termination attribute information of the control may include position information of the control when the terminal leaves factory, and some other necessary information related to the control or the application. It can thus be seen that the termination attribute information of the control may be used for identifying the interface layout. The interface in which the control is positioned and the interface layout of the interface may be acquired by virtue of the termination attribute information of the control. In the above embodiment, when positions of two or more than two different controls in the same interface are changed, a new adapted layout file may be generated after the position of each control is changed, that is, each control may correspond to one adapted interface layout file after the position of the control is changed. Of course, after positions of multiple different controls in the same interface are changed, the current interface may correspond to one newly generated adapted layout file, and the newly generated adapted layout file may reflect a new corresponding control layout after the positions of the multiple different controls in the interface are changed.

In an exemplary embodiment, after the step that the control is displayed at the termination position of the changed interface layout, the method further includes that: when the control is displayed again after the interface is quitted, the control is displayed at the termination position in the interface layout adapted to the termination position. That is, when the control is displayed again after the position of the control is changed, it can be ensured that the control is displayed at the position after changing, then the user is not required to set the position of the control again, and a user experience is improved. In the embodiment of the present disclosure, a switch used for enabling a dynamic control layout function may be arranged in the mobile terminal. When the switch is turned on, the user is allowed to dynamically lay out positions of controls again according to his/her own using habit. When the switch is turned off, the dynamic layout function is disabled. A switch for recovering an initial setting may also be arranged in the mobile terminal. The dynamically laid-out controls may be recovered to control positions when the mobile terminal leaves factory by virtue of turning on the switch for recovering the initial setting.

The embodiment further provides a control display device. The device is arranged to implement the abovementioned embodiment and exemplary implementation modes, and what has been described will not be elaborated. For example, term “module”, used below, may be a combination of software and/or hardware capable of realizing a preset function. Although the device described in the following embodiment is preferably implemented with software, implementation with hardware or a combination of the software and the hardware is also possible and conceivable.

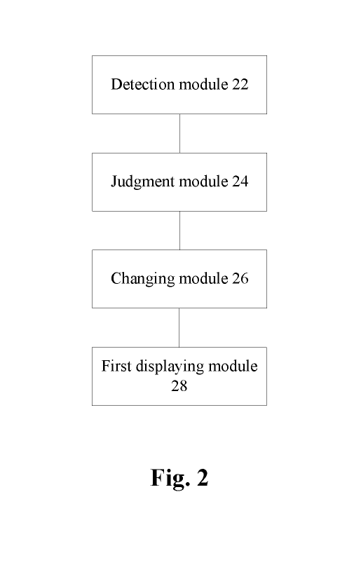

FIG. 2 is a structure block diagram of a control display device according to an embodiment of the present disclosure. As shown in FIG. 2, the device includes a detection module 22, a judgment module 24, a changing module 26 and a first displaying module 28. The device will be described below.

The detection module 22 is arranged to detect that a position of a control, for being displayed, on an interface of a mobile terminal is changed. The judgment module 24 is coupled to the detection module 22, and is arranged to judge whether a termination position after changing is located in a preset interface layout in the mobile terminal or not. The changing module 26 is coupled to the judgment module 24, and is arranged to, under a condition that a judgment result of the judgment module 24 is that the termination position after changing is not located in the preset interface layout, change the preset interface layout into an interface layout adapted to the termination position of the control. The first displaying module 28 is coupled to the changing module 26, and is arranged to display the control at the termination position of the changed interface layout.

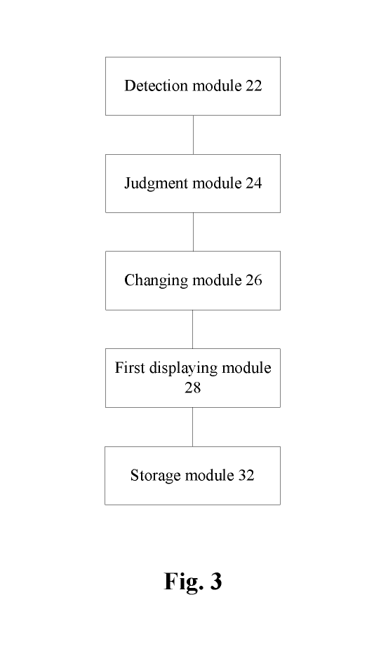

FIG. 3 is a first exemplary structure block diagram of a control display device according to an embodiment of the present disclosure. As shown in FIG. 3, the device further, besides all the modules shown in FIG. 2, includes a storage module 32. The storage module 32 will be described below.

The storage module 32 is coupled to the first displaying module 28, and is arranged to store termination attribute information used for recording to display the control at the termination position of the changed interface layout.

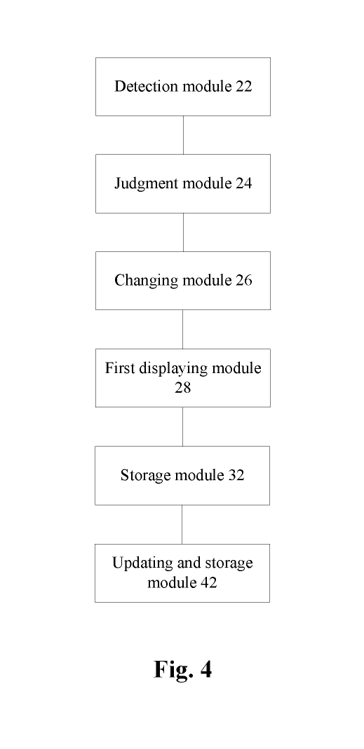

FIG. 4 is a second exemplary structure block diagram of a control display device according to an embodiment of the present disclosure. As shown in FIG. 4, the device further, besides all the modules shown in FIG. 3, includes an updating and storage module 42. The updating and storage module 42 will be described below.

The updating and storage module 42 is coupled to the storage module 32, and is arranged to, under a condition of detecting that the position of the control, for being displayed, is changed for multiple times, update and store multiple pieces of termination attribute information corresponding to the control of which the position is detected to be changed for multiple times.

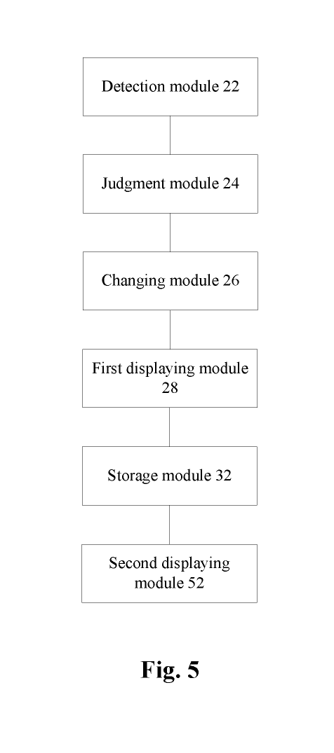

FIG. 5 is a third exemplary structure block diagram of a control display device according to an embodiment of the present disclosure. As shown in FIG. 5, the device further, besides all the modules shown in FIG. 3, includes a second displaying module 52. The second displaying module 52 will be described below.

The second displaying module 52 is coupled to the storage module 32, and is arranged to, when the control is displayed again after the interface is quitted, display the control at the termination position of the changed interface layout.

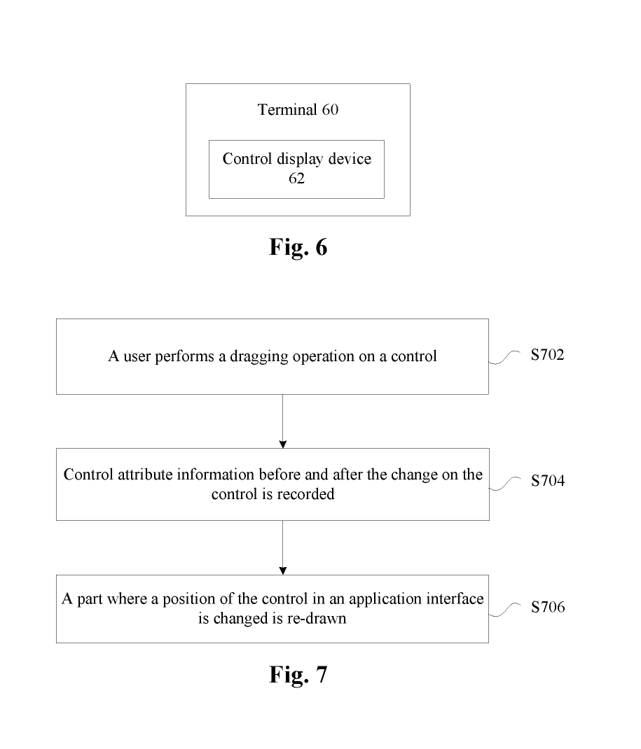

FIG. 6 is a structure block diagram of a terminal according to an embodiment of the present disclosure. As shown in FIG. 6, the terminal 60 includes any abovementioned control display device 62.

In order to solve the problem that a user can regulate a menu or a sequence of menu items only after use of a period of time in the related technology, that is, the user can regulate the sequence of the menu items only by constructing statistical data in a using process, or that a control such as a picture button cannot be placed at a position which is not an integral multiple of a set interval in the related technology, the embodiment of the present disclosure further provides a method for dynamically laying out application controls of a mobile terminal.

The embodiment will be described below with reference to a specific implementation mode.

A core principle of the embodiment of the present disclosure is that: the mobile terminal enables the user to regulate control positions in an application interface according to his/her own personal using habit or preference for the mobile terminal by supporting the user to dynamically lay out control elements of the application interface. In this way, usability of the mobile terminal is finally improved, and the personal using habit or preference of the user is met.

FIG. 7 is a schematic diagram of modifying a control of an application interface by a user according to an embodiment of the present disclosure. As shown in FIG. 7, when the user performs control position modification on a certain control in the application interface, the following steps may be included.

Step 702: when the user performs a control position dragging operation on a certain control in the application interface by long pressing, movement of the control in the application interface is implemented. By this operation, a purpose of redefining a position of the control by the user is achieved, that is, the user can freely perform dynamic position layout on the position of the control of the application interface according to his/her own using habit or preference.

Step S704: the mobile terminal records position changing information of the moved control on the application interface. The mobile terminal may record the position changing information of the control into an attribute information record (the same as the abovementioned termination attribute information of the control) of the control.

Step S706: the mobile terminal re-draws the application interface, namely refreshes the position of the moved control, according to attribute information of the moved control.

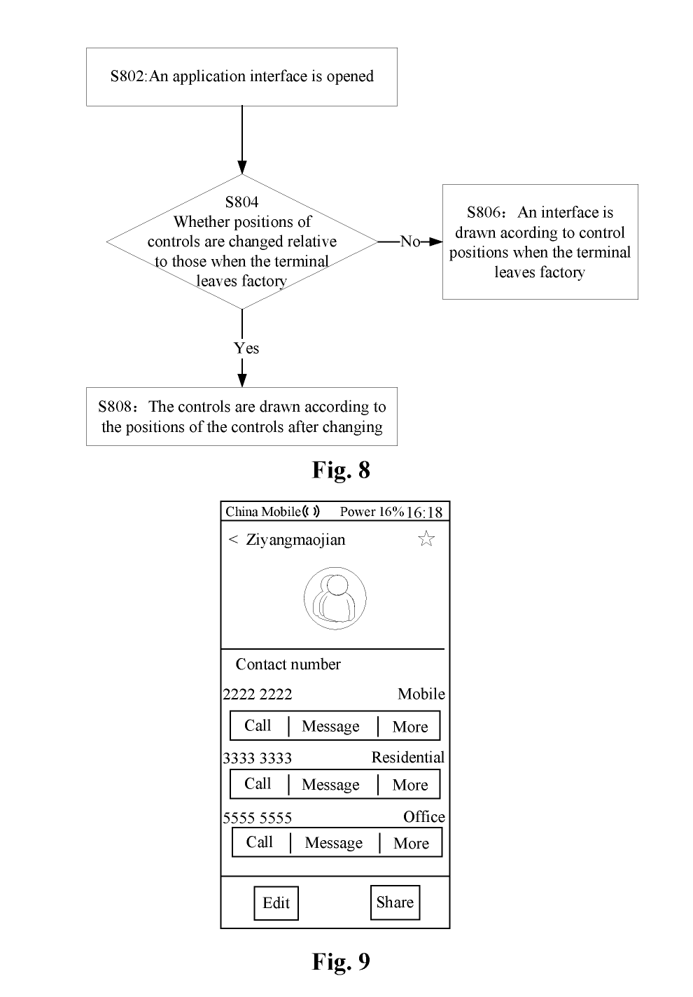

FIG. 8 is a drawing diagram of positions of controls according to an embodiment of the present disclosure. When an application is started and a certain interface of the application is opened, an interface drawing diagram is opened, as shown in FIG. 8.

Step S802: a certain application interface of the mobile terminal is opened.

Step S804: the mobile terminal judges whether a position of each control in the application interface is changed relative to a control position when the mobile terminal leaves factory or not. Whether the position is changed or not may be judged according to whether attribute information of each control in the interface is stored in a control attribute or not. If the information of the control does not exist in a control attribute record, it may be considered that the user does not move the control. If the attribute information (the same as the abovementioned termination attribute information) of the control exists in the control attribute record, it may be considered that the user moves the control.

Step S806: if the attribute information of the control does not exist in the control attribute record, the application interface may be drawn according to the positions of the controls when the terminal leaves factory.

Step S808: if the attribute information of the control exists in the control attribute record, the interface is drawn in which the position of the control in the application interface of the mobile terminal is a control position indicated by the attribute information of the control in the control attribute record.

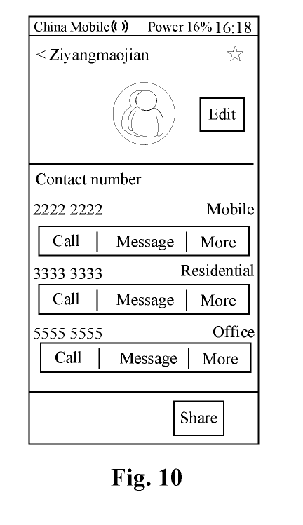

FIG. 9 is an original layout of an interface of a mobile phone according to an embodiment of the present disclosure. FIG. 10 is a layout of an interface of a mobile phone after control movement according to an embodiment of the present disclosure.

As shown in FIG. 9, in a detail interface of a contact, the user may long-press and drag a control to change a position of a control from a position, which is set when the mobile phone leaves factory, to a position expected by the user.

In FIG. 9, when the mobile terminal leaves factory, a position of a control “edit” in the detail interface of the contact is located at a bottom of the detail interface of the contact.

In FIG. 10, the user long-presses and drags “edit” to a new position in the vicinity of a portrait position.

In FIG. 10, when the user moves the control “edit” to the new position, related attribute information of “edit” is recorded, and when the user enters the detail interface of the contact next time, “edit” is located at the new position.

Compared with the related technology, the technical scheme provided by the embodiments of the present disclosure has the following advantages. On one hand, the technical scheme can overcome a shortcoming that layout positions of controls are all fixed or the positions of the controls cannot be changed in the related technology. By virtue of the technical scheme, a user can change a layout of the controls in an interface according to his/her own using habit or using preference, and usability and operability of a mobile terminal for the user are further improved. A shortcoming of greatly different user experiences when the same mobile terminal is used by different users is finally solved.

Meanwhile, by adopting the technical scheme of the embodiments of the present disclosure, the user can dynamically lay out of the controls of the application interface of the mobile terminal anytime, and can freely move the positions of the controls. Therefore, the shortcoming that the user can regulate a menu or menu items only after statistical data is formed after use of a period of time in the related technology is solved.

Obviously, those skilled in the art should know that each module or each step of the present disclosure may be implemented by a universal computing device, and the modules or steps may be concentrated on a single computing device or distributed on a network formed by a plurality of computing devices, and may optionally be implemented by program codes executable for the computing devices, so that the modules or steps may be stored in a storage device for execution with the computing devices, the shown or described steps may be executed in sequences different from those described here in some circumstances, or may form each integrated circuit module respectively, or multiple modules or steps therein may form a single integrated circuit module for implementation. As a consequence, the present disclosure is not limited to any specific hardware and software combination.

The above is only the exemplary embodiment of the present disclosure and not intended to limit the present disclosure. For those skilled in the art, the present disclosure may have various modifications and variations. Any modifications, equivalent replacements, improvements and the like made within the principle of the present disclosure shall fall within the scope of protection defined by the appended claims of the present disclosure.

### INDUSTRIAL APPLICABILITY

By the abovementioned embodiments and exemplary implementation modes, the problem that a user cannot freely regulate a position of a control on a terminal immediately after getting the terminal in the related technology is solved. An effect that the user can freely regulate the position of the control according to his/her own preference is further achieved.

1. A control display method, comprising:
detecting that a position of a control, for being displayed, on an interface of a mobile terminal is changed;
judging whether a termination position after changing is located in a preset interface layout in the mobile terminal or not;
under a condition that a judgment result is that the termination position after changing is not located in the preset interface layout, changing the preset interface layout into an interface layout adapted to the termination position of the control; and
displaying the control at the termination position of the changed interface layout.

2. The method as claimed in claim 1, after displaying the control at the termination position of the changed interface layout, further comprising:
storing termination attribute information used for recording to display the control at the termination position of the changed interface layout.

3. The method as claimed in claim 2, after storing the termination attribute information used for recording to display the control at the termination position of the changed interface layout, further comprising:
under a condition of detecting that the position of the control, for being displayed, is changed for multiple times, updating and storing multiple pieces of termination attribute information corresponding to the control of which the position is detected to be changed for multiple times.

4. The method as claimed in claim 2, wherein the termination attribute information of the control comprises at least one of:
a name of an application to which the control belongs, a name of the interface in which the control is positioned, a control name or control Identity (ID) of the control, a category of the control, the changed interface layout, and termination position information after the position of the control is changed for one or multiple times.

5. The method as claimed in claim 2, after displaying the control at the termination position of the changed interface layout, further comprising:
when the control is displayed again after the interface is quitted, displaying the control at the termination position of the changed interface layout.

6. A control display device, comprising a hardware processor arranged to execute the following program modules:
a detection module, arranged to detect that a position of a control, for being displayed, on an interface of a mobile terminal is changed;
a judgment module, arranged to judge whether a termination position after changing is located in a preset interface layout in the mobile terminal or not;
a changing module, arranged to, under a condition that a judgment result of the judgment module is that the termination position after changing is not located in the preset interface layout, change the preset interface layout into an interface layout adapted to the termination position of the control; and
a first displaying module, arranged to display the control at the termination position of the changed interface layout.

7. The device as claimed in claim 6, the hardware processor is arranged to further execute the following program module:
a storage module, arranged to store termination attribute information used for recording to display the control at the termination position of the changed interface layout.

8. The device as claimed in claim 7, the hardware processor is arranged to further execute the following program module:
an updating and storage module, arranged to, under a condition of detecting that the position of the control, for being displayed, is changed for multiple times, update and store multiple pieces of termination attribute information corresponding to the control of which the position is detected to be changed for multiple times.

9. The device as claimed in claim 7, the hardware processor is arranged to further execute the following program module:
a second displaying module, arranged to, when the control is displayed again after the interface is quitted, display the control at the termination position of the changed interface layout.

10. A terminal, comprising the control display device according to claim 6.

11. The method as claimed in claim 3, wherein the termination attribute information of the control comprises at least one of:
a name of an application to which the control belongs, a name of the interface in which the control is positioned, a control name or control Identity (ID) of the control, a category of the control, the changed interface layout, and termination position information after the position of the control is changed for one or multiple times.

12. The method as claimed in claim 3, after displaying the control at the termination position of the changed interface layout, further comprising:
when the control is displayed again after the interface is quitted, displaying the control at the termination position of the changed interface layout.

13. The device as claimed in claim 7, wherein the termination attribute information of the control comprises at least one of:
a name of an application to which the control belongs, a name of the interface in which the control is positioned, a control name or control Identity (ID) of the control, a category of the control, the changed interface layout, and termination position information after the position of the control is changed for one or multiple times.

14. The device as claimed in claim 8, wherein the termination attribute information of the control comprises at least one of:
a name of an application to which the control belongs, a name of the interface in which the control is positioned, a control name or control Identity (ID) of the control, a category of the control, the changed interface layout, and termination position information after the position of the control is changed for one or multiple times.

15. The device as claimed in claim 8, the hardware processor is arranged to further execute the following program module:
a second displaying module, arranged to, when the control is displayed again after the interface is quitted, display the control at the termination position of the changed interface layout.

16. A terminal, comprising the control display device according to claim 7.

17. A terminal, comprising the control display device according to claim 8.

18. A terminal, comprising the control display device according to claim 9.

19. A terminal, comprising the control display device according to claim 13.

20. A terminal, comprising the control display device according to claim 15.
